(19) United States
(12) Patent Application Publication
(10) Pub. No.: US 2023/0072274 A1
(43) Pub. Date: Mar. 9, 2023

(54) METHOD FOR OVERCOMING CATASTROPHIC FORGETTING THROUGH NEURON-LEVEL PLASTICITY CONTROL, AND COMPUTING SYSTEM PERFORMING SAME

(71) Applicant: DEEP BIO, INC., Seoul (KR)

(72) Inventors: In Young PAIK, Seoul (KR); Sang Jun OH, Seoul (KR); Tae Yeong KWAK, Seoul (KR)

(21) Appl. No.: 17/795,546

(22) PCT Filed: Jul. 24, 2020
(86) PCT No.: PCT/KR2020/009823

§ 371 Date: Jul. 27, 2022

(30) Foreign Application Priority Data
Jan. 28, 2020 (KR) 10-2020-0009615

(51) Int. Cl. G06N 3/08; G06N 3/04

(52) U.S. Cl. CPC G06N 3/08; G06N 3/049

(57) ABSTRACT

A neuron-level plasticity control (NPC) addresses the issue of catastrophic forgetting in an artificial neural network. The plasticity of a network is controlled at a neuron level rather than at a connection level during training of a new task, thereby conserving existing knowledge. The neuron-level plasticity control evaluates the importance of each neuron and applies a low training speed to integrate important neurons. In addition, a scheduled NPC (SNPC) is provided that uses training schedule information to more clearly protect important neurons.

### CROSS REFERENCE TO RELATED APPLICATIONS

This application is a National Stage Entry of International Application No. PCT/KR2020/009823, filed Jul. 24, 2020, and claims priority from and benefit of Korean Patent Application No. KR-10-2020-0009615, filed Jan. 28, 2020, each of which is incorporated by reference for all purposes as if fully set forth herein.

### TECHNICAL FIELD

In order to solve the issue of catastrophic forgetting in an artificial neural network, a simple and effective solution called neuron-level plasticity control (NPC) is described hereinbelow

### BACKGROUND

In the process of realizing artificial general intelligence using a deep neural network, catastrophic forgetting is one of the most fundamental challenges. The gradient descent, which is the most frequently used learning method, generates problems when it is applied to train a neural network for multiple tasks in a sequential manner. When the gradient descent optimizes the neural network for a current task, knowledge about previous tasks is catastrophically overwritten by new knowledge, thereby resulting in sub-optimal performance of the neural network.

### SUMMARY

Aspects consistent with one or more embodiments of the invention show the limitations of the EWC and provide an improved method called neuron-level plasticity control (NPC). As can be derived from the name, the NPC method maintains existing knowledge by controlling plasticity of each neuron or each filter in a Convolutional Neural Network (CNN). This is in contrast to the EWC, which works by consolidating individual connection weights. Another important characteristic of the NPC embodiment is to stabilize important neurons by adjusting the learning rates, rather than maintaining important parameters to be close to a specific value. Such a characteristic may increase efficiency of memory, in addition to increasing the efficiency of the NPC embodiment, regardless of the number of tasks. That is, since the NPC embodiment only needs to store a single importance value per neuron, instead of a set of parameter values for each task, the amount of memory use may be consistently maintained regardless of the number of tasks.

Previous studies generally assume that an accurate timing of task switching is known. Accordingly, the learning method may explicitly maintain and switch contexts, such as several sets of parameter values, whenever a task changes. On the other hand, the NPC embodiment controls plasticity of neurons by continuously evaluating importance of each neuron without maintaining information and simply adjusting the learning rate according to the moving average of the importance. Therefore, NPC does not require information about the learning schedule, except the identifier (ID) of the current task, which is essentially needed to compute classification loss. On the other hand, the NPC embodiment may be further improved when there is a predetermined learning schedule. To this end, an extension of the NPC embodiment, referred to as a scheduled NPC (SNPC), is provided as another embodiment to more clearly preserve important neurons according to a learning schedule. For each task, the SNPC embodiment identifies and consolidates important neurons while training other tasks. Experiment results show that the NPC and SNPC embodiments are practically more effective in reducing catastrophic forgetting than the connection-level consolidation approach. In particular, the effect of catastrophic forgetting almost disappears in the evaluation of the SNPC embodiment on the iMNIST dataset.

At least one embodiment provides for a method of overcoming catastrophic forgetting through neuron-level plasticity control (NPC).

At least one embodiment provides a computing system that performs the method of overcoming catastrophic forgetting through neuron-level plasticity control (NPC).

Results of experiments on incremental MNIST (iMNIST) and incremental CIFAR100 datasets using the NPC and SNPC embodiments show that the NPC and SNPC methods are remarkably effective in comparison with connection-level integrated access methods, and in particular, the SNPC method exhibits excellent performance for the two datasets.

### BRIEF DESCRIPTION OF THE DRAWINGS

To more sufficiently understand the drawings cited in the detailed description provided below, a brief description of each drawing is provided.

FIG. 1 is a view for comparing connection-level consolidation and neuron-level consolidation. In particular, area (a) shows neurons and connections important for Task 1, area (b) shows connection-level consolidation, and area (c) shows neuron-level consolidation. Although important connections are consolidated, neurons may be affected by other incoming connections that may change while learning Task 2. NPC according to an embodiment consolidates all incoming connections of important neurons, which are more effective in preserving knowledge of the neurons.

FIG. 2 shows an example of a histogram of importance values Ci. In particular, area (a) in FIG. 2 is a graph showing an original distribution before equalization, and area (b) of FIG. 2 is a graph showing an equalized distribution.

FIG. 3 shows verification accuracy of the continual learning method on an iMNIST dataset. In particular, area (a) at the top portion of FIG. 3 shows average verification accuracy of tasks trained up to each moment, and area (b) at the lower portion of FIG. 3 shows training curves of five tasks according to the learning method. SNPC and NPC according to embodiments respectively show the best performance among continual learning methods.

FIG. 4 shows validity verification accuracy of the continual learning method on an iCIFAR100 dataset. In particular, area (a) at the top portion of FIG. 4 shows average verification accuracy of a task trained up to each moment, and area (b) at the lower portion of FIG. 4 shows training curves of five tasks according to the learning method. SNPC and NPC according to embodiments respectively show the best performance among continual learning methods. Difference between training curves is more remarkable in iCIFAR100 than in iMNIST.

FIG. 5 shows training curves of the fifth iCIFAR100 task under different settings. In particular, curve (a) corresponds to a training curve of SNPC according to an embodiment learning T₅ after learning T₁ to T₄, curve (b) corresponds to a training curve of partial training of a full VGG net, in which only 14.33% (= r₅) of neurons are allowed to change from randomly initialized parameters, and curve (c) corresponds to a training curve of training of a partial VGG net, starting from randomly initialized parameters and reduced only to have 14.33% of the original model.

FIG. 6 is a block diagram showing a schematic configuration of a computing system according to an embodiment.

FIG. 7 is a flowchart illustrating a neuron-level plasticity control method performed by a computing system according to an embodiment.

FIG. 8 is a flowchart illustrating a scheduled neuron-level plasticity control method performed by a computing system according to an embodiment.

### DETAILED DESCRIPTION

To help in the understanding of embodiments as described hereinbelow, studies that work as the theoretical background regarding how embodiments of the invention were developed will be introduced first, after a brief description of NPC according to an embodiment and SNPC according to another embodiment.

A simple and effective solution called neuron-level plasticity control (NPC) is provided according to an embodiment order to solve the issue of catastrophic forgetting in an artificial neural network. The NPC method according to an embodiment preserves existing knowledge by controlling the plasticity of a network at a neuron level rather than at a connection level during training of a new task. The neuron-level plasticity control evaluates the importance of each neuron and applies a low training speed to integrate important neurons.

In addition, an extension of NPC, called scheduled NPC, or SNPC, is provided according to another embodiment. This extension uses training schedule information to more clearly protect important neurons. Results of experiments on incremental MNIST (iMNIST) and incremental CIFAR100 datasets show that NPC and SNPC according to embodiments are remarkably effective in comparison to connection-level integrated access methods, and in particular, SNPC according to another embodiment exhibits excellent performance for the two datasets.

In the process of realizing artificial general intelligence with deep neural networks, catastrophic forgetting is still one of the most fundamental challenges. The gradient descent, which is the most frequently used learning method, generates problems when it is applied to train a neural network for multiple tasks in a sequential manner. When the gradient descent optimizes the neural network for a current task, knowledge about previous tasks is catastrophically overwritten by new knowledge.

After the initial discovery of the overwriting problem that results in catastrophic forgetting [see McCloskey Cohen (1989) McCloskey and Cohen], various approaches have been proposed in the past to alleviate catastrophic forgetting in artificial neural networks. One of the approaches is to include data for multiple tasks in all mini-batches. Although such a method may be effective in maintaining performance of the previous tasks, an overhead of maintaining training data for the previous tasks is generated. Several attempts have been made to achieve a similar effect using only a limited part of the previous data [see Gepperth Karaoguz (2016) Gepperth and Karaoguz, Lopez-Paz (2017)] or without using the previous data [Li Hoiem (2018) Li and Hoiem, Shin et al. (2017) Shin, Lee, Kim, and Kim, Kamra et al. (2017) Kamra, Gupta, and Liu, Zacarias Alexandre (2018) Zacarias and Alexandre, Kim et al. (2018) Kim, Kim, and Lee].

Another approach attempted in the past is to isolate a part of the neural network that contains previous knowledge, and learn a new task using other parts of the network. This includes designing dynamic architectures for neural networks that may learn new tasks by assigning different parts of the network to the new tasks. [see Fernando et al. (2017) Fernando, Banarse, Blundell, Zwols, Ha, Rusu, Pritzel, and Wierstra, Aljundi et al. (2017) Aljundi, Chakravarty, and Tuytelaars, Lee et al. (2017) Lee, Yun, Hwang, and Yang] Since the proposed method learns multiple tasks using the other parts of the network, the present invention is closely related to this approach. Here, the unit of a part is an individual neuron.

Elastic weight consolidation (EWC) [see Kirkpatrick et al. (2017) Kirkpatrick, Pascanu, Rabinowitz, Veness, Desjardins, Rusu, Milan, Quan, Ramalho, Grabska-Barwinska, et al.] is a notable development made in this field to address this overwriting issue. Using diagonal lines of a Fisher information matrix, EWC identifies and consolidates parameters corresponding to the connection weights of neural networks important to previous tasks. In this way, a network may learn new tasks using less important parameters while maintaining previously learned knowledge. As the EWC has attracted much attention, it has been adopted in many studies [see Lee et al. (2017) Lee, Kim, Jun, Ha, Zhang, Nguyen et al. (2017) Nguyen, Li, Bui, and Turner, Liu et al. (2018) Liu, Masana, Herranz, Van to de Weijer, Lopez and Bagdanov, Zenke et al. (2017) Zenke, Poole, Ganguli] . There is a significant room for improvement in the performance of the EWC alone [see Parisi et al. (2018) Parisi, Kemker, Part, Kanan, Wermter]. In recent studies, EWC has been used in combination with other methods as a means for normalization [see Kim et al. (2018) Kim, Kim, and Lee, Lee et al. (2017) Lee, Yun, Hwang, and Yang] .

Aspects consistent with one or more embodiments address the limitations of the EWC and provide for an improved method and system called neuron-level plasticity control, NPC. As is known from the name, the NPC embodiment maintains existing knowledge by controlling plasticity of each neuron or each filter in a Convolutional Neural Network (CNN). This is in contrast to EWC, which works by consolidating individual connection weights. Another important characteristic of NPC according to an embodiment is to stabilize important neurons by adjusting the learning rate, rather than maintaining important parameters to be close to a specific value. In addition to increasing efficiency of NPC according to another embodiment, such a characteristic may increase memory efficiency regardless of the number of tasks. That is, since NPC according to another embodiment only needs to store a single importance value per neuron, instead of a set of parameter values for each task, the amount of memory use may be consistently maintained regardless of the number of tasks.

Previous studies, like EWC, generally assume that an accurate timing of task switching is known. Accordingly, the learning methods may explicitly maintain and switch contexts, such as several sets of parameter values, whenever a task changes. On the other hand, NPC according to an embodiment controls plasticity of neurons by continuously evaluating importance of each neuron without maintaining information and simply adjusting the learning rate according to the moving average of the importance. Therefore, NPC according to an embodiment does not require information about the learning schedule, except the identifier (ID) of the current task, which is essentially needed to compute classification loss. Furthermore, NPC according to an embodiment may operate even better when there is a predetermined learning schedule. To this end, an extension of NPC referred to as a scheduled NPC, or SNPC, is provided according to another embodiment, to more clearly preserve important neurons according to the learning schedule. For each task, SNPC according to another embodiment identifies and consolidates important neurons while training other tasks. Experiment results show that NPC and SNPC are practically more effective in reducing catastrophic forgetting than the connection-level consolidation approach. In particular, the effect of catastrophic forgetting almost disappears in the evaluation of SNPC according to another embodiment on the iMNIST dataset.

### Neuron-level Versus Connection-level Consolidation

Although EWC and its subsequence studies [see Kirkpatrick et al. (2017) Kirkpatrick, Pascanu, Rabinowitz, Veness, Desjardins, Rusu, Milan, Quan, Ramalho, Grabska-Barwinska, et al., Lee et al. (2017) Lee , Kim, Jun, Ha, and Zhang, Nguyen et al. (2017) Nguyen, Li, Bui, and Turner, Liu et al. (2018) Liu, Masana, Herranz, Van~de Weijer, Lopez, and Bagdanov , Zenke et al. (2017) Zenke, Poole, and Ganguli] focus on the concept that knowledge is stored in the connection weights of neural networks, the correlation between these connections is not emphasized. The loss function of EWC is defined as shown in Equation (1). Here, Tₙ denotes an n-th task.

$${\text{LOSS}}_{\text{EWC}} = {\text{Loss}}_{{T}_{n}} + \sum {}_{k < n} \sum {}_{i} \frac{λ}{2} {F}_{i} {\left({θ}_{i} - {θ}_{i , {T}_{n}}\right)}^{2}$$

There is an implicit assumption that the weights of neural networks are roughly independent, and a neural network may be linearly approximated by its weights. However, the structures of deep neural networks are inherently hierarchical, and there is a strong correlation between parameters. Therefore, since parameter values may affect importance of other values, it is inappropriate to independently consider the connection weights as is done in EWC.

It is the case that neurons or CNN filters are more appropriate than individual connections for the basic unit of knowledge in consolidation of artificial neural networks. Conventional connection-level methods do not guarantee preservation of important knowledge expressed by neurons. Although the learning method consolidates some connections to important neurons, the neurons may have maintained free incoming connections, and a change in these connections may severely affect the knowledge carried by the neuron.

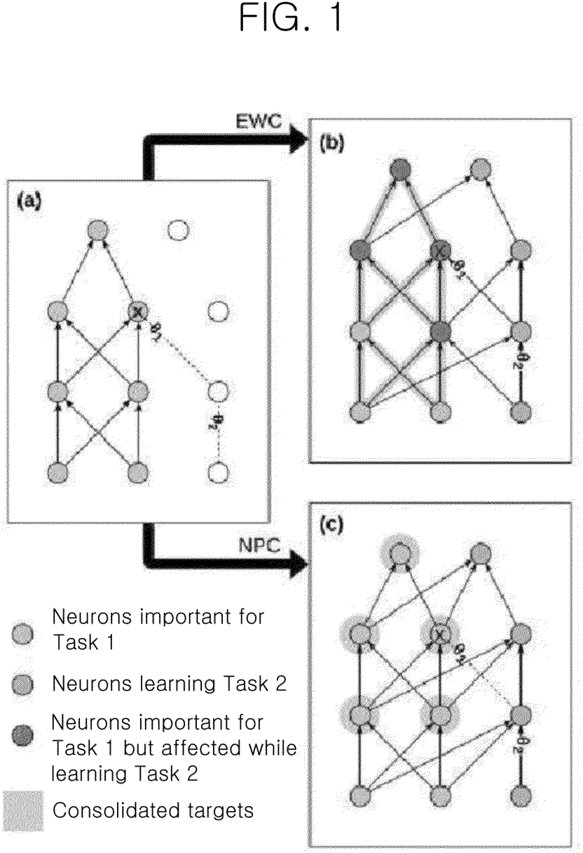

FIG. 1 shows the limitation of the connection-level consolidation of deep neural networks more clearly. In FIG. 1, the values of connection weights θ₁ and θ₂ are close to 0, and this allows the learning methods to evaluate their importance as minimum. That is, changing the values of θ₁ and θ₂ individually does not significantly affect the output of Task 1. In this situation, the connection level method does not consolidate two connection parameters due to the minimal importance. However, when both parameters rapidly increase in subsequent learnings, it may seriously affect Task 1. It is since that they are closely related to each other. This problem may be particularly severe in convolutional layers in which the same filters are shared among multiple output nodes at different positions. Therefore, although the concept of connection-level consolidation may be fully implemented, catastrophic forgetting cannot be completely eliminated.

To overcome this problem, there is provided to control plasticity at the neuron-level rather than at the connection-level as shown in area (c) of FIG. 1. The NPC method according to an embodiment consolidates all incoming connections of important neurons, including connections that may not be evaluated as important individually. As a result, NPC according to an embodiment protects more important neurons from the change of unimportant neurons more effectively than the connection-level consolidation methods.

The connection from an unimportant neuron Y to an important neuron X may be small. It is since that the evaluation method determines Y as an important neuron otherwise. In the example shown in FIG. 1, since NPC according to an embodiment consolidates all incoming connections of X, the value of θ₁ remains small as a result, so that change of θ₂ does not seriously affect X. On the other hand, NPC according to an embodiment does not consolidate connections of which destination neurons are unimportant although they are individually important. Accordingly, the total number of consolidated connections in the whole network is acceptable.

### Neuron-Level Plasticity Control

### Importance Evaluation

To evaluate importance of each neuron, according to an embodiment a criterion is adjusted based on Taylor extension used in the field of network pruning [see Molchanov et al. (2016) Molchanov, Tyree, Karras, Aila and Kautz]. Although there are other methods that insist better performance in network theorem [see Yu et al. (2018) Yu, Li, Chen, Lai, Morariu, Han, Gao, Lin, Davis, Luo Wu (2017) Luo and Wu Luo et al. (2017) Luo, Wu, Lin], the Taylor criterion is selected due to computational efficiency. The Taylor criterion is computed from the gradient of the loss function with respect to neurons computed during back-propagation. Therefore, this may be easily integrated into the training process with minimal additional computation.

In this study, importance of i-th neuron nᵢ at time t is defined as a moving average of a normalized Taylor criterion expressed as shown in Equation (4). Here, N_{layer} is the number of nodes on a layer.

$$a v e r a g {e}_{b a t c h} \left|{n}_{i}^{\left(t\right)} \frac{d {L}^{\left(t\right)}}{d {n}_{i}^{\left(t\right)}}\right|$$

$${\hat{c}}_{l} {}^{\left(t\right)} = \frac{{c}_{i}^{\left(t\right)}}{\sqrt{\sum l a y e r {\left({c}_{j}^{\left(t\right)}\right)}^{2} {/}^{N} l a y e r}}$$

$${C}_{i}^{\left(t\right)} = δ {C}_{i}^{\left(t - 1\right)} + \left(1 - δ\right) {\hat{c}}_{l} {}^{\left(t\right)}$$

When a node is shared at multiple positions (e.g., a convolution filter of CNN), an average of importance values is computed, before considering an absolute value, at all positions according to the original paper [see Molchanov et al. (2016) Molchanov, Tyree, Karras, Aila, and Kautz]. However, a quadratic mean is used as shown in Equation (3) instead of L2-norm in order to maintain a stricter balance among the layers configured of different numbers of neurons.

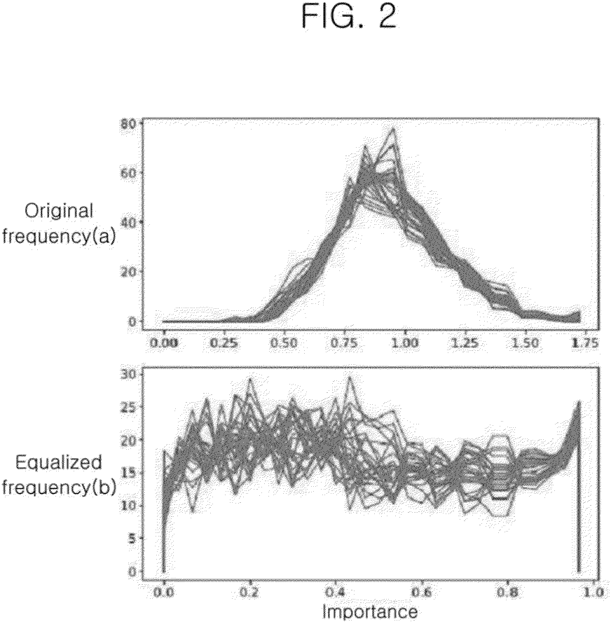

In the initial experiments, it is found that the distribution is approximately Gaussian as shown in area a) of FIG. 2. The distribution is equalized into a uniform distribution using Equation (5) shown below in order to better distinguish relative importance. Here,

$$e r f c ( x ) = \frac{2}{\sqrt{\text{π}}} {\int }_{x}^{∞} {e}^{- {t}^{2}} d t$$

is a complementary error function [see Wikipedia contributors (2018)]. Area (b) of FIG. 2 shows distribution of importance after equalization.

$${D}_{i} {}^{\left(t\right)} = \frac{1}{2} e r f c \left(- \frac{1}{\sqrt{2}} \frac{{c}_{i}^{\left(t\right)} - {μ}_{l a y e r}}{{σ}_{l a y e r}}\right)$$

### Plasticity Control

The stability-plasticity dilemma is a well-known constraint in both artificial and biological neural systems [see Mermillod et al. (2013) Mermillod, Bugaiska, Bonin]. Catastrophic forgetting may be considered as a consequence of the same trade-off problem (i.e., attempting to determine an optimal point that maximizes performance of the neural network for multiple tasks). Plasticity of each neuron is controlled by applying a different learning rate nᵢ to each neuron nᵢ. When nᵢ is high, neurons actively learn new knowledge at the cost of rapidly losing existing knowledge. On the contrary, when nᵢ is low, existing knowledge may be better preserved. However, the neurons will be reluctant to learn new knowledge.

In order to encourage neural networks to find a good stability-plasticity balance, in an embodiment, two losses are defined as functions of n₁ that perform opposite roles, and then the functions are combined. The first one is a loss from the perspective of stability for minimizing forgetting of existing knowledge. It is a function monotonically increasing starting at n₁ = 0 and should be limited by the amount of current knowledge. The upper bound of the current knowledge is heuristically approximated using a₁tC₁ (here, a₁ is a scaling constant, and t ≥ 1 is currently in the training step). Here, since new tasks are provided at a constant rate in this experiment, it is assumed that the total amount of knowledge is directly proportional to the training time. To make a monotonically increasing function of n₁, tanh(b₁n) is combined with the upper bound. Here, b₁ is another constant for controlling the gradient of the tanh function. Consequently, the stability-loss is defined as a₁tC₁tanh (b₁nᵢ).

The second function is a loss from the perspective of plasticity for decreasing reluctance to new knowledge. It is a decreasing function of n₁ starting from the upper bound nᵢ=0 and monotonically decreasing to 0. In this case, the upper bound does not consider existing knowledge and therefore is unrelated to Ci or t. Accordingly, the plasticity-wise loss is defined as a₂(1-tanh(b₂nᵢ)). Here, a₂ and b₂ are constants for controlling the scale and the gradient.

In order to find the balance between stability and plasticity, n₁ that minimizes the combined loss function of Equation (6) shown below is selected.

$${a r \text{} g m i \text{} n}_{{η}_{1}} f \left({η}_{1}\right) = {a r \text{} g m i \text{} n}_{{η}_{1}} \left\{{a}_{1} t {C}_{i} t a \text{} n h \left({b}_{1} {η}_{1}\right) + {a}_{2} \left(1 - t a n h \left({b}_{2} {η}_{i}\right)\right)\right\}$$

Equation (7) shown below is obtained by setting

$$\frac{d f}{d {n}_{1}} = 0.$$

Here,

$$β = \frac{{a}_{2} {b}_{2}}{{a}_{1} {b}_{1}} .$$

$${a}_{1} {b}_{1} t {C}_{1} {sech}^{2} \left({b}_{1} η\right) - {a}_{2} {b}_{2} {sech}^{2} \left({b}_{2} η\right) = 0$$

$$⇔ \frac{c o s h \left({b}_{2} η\right)}{c o s h \left({b}_{1} η\right)} = \sqrt{\frac{{a}_{2} {b}_{2}}{{a}_{1} {b}_{1} t {C}_{1}}} = \sqrt{\frac{β}{t {C}_{1}}}$$

The property of function

$$\frac{cosh ( {b}_{2} η )}{cosh ( {b}_{1} η )}$$

largely depends on whether b₁ ≥ b2 or b₁ < b₂ When b₁ ≥ b₂, the optimal ηᵢ becomes a simple step function. Therefore, b₁ < b₂ is set as a constraint.

When tCᵢ > β, ƒ(ηᵢ) strictly increases with respect to ηᵢ, and the optimal ηᵢ is a minimum value, i.e., ηᵢ=0 . In the case of tCᵢ ≥ β, a Taylor approximation is applied to solve Equation (7). This is since that a closed form inverse function

$$\frac{cosh ( {b}_{2} η )}{cosh ( {b}_{1} η )}$$

of does not exist. When cosh is an even function, only the even degree terms remain as shown in Equation (9).

$$\frac{c o s h \left({b}_{2} {η}_{i}\right)}{c o s h \left({b}_{1} {η}_{i}\right)} = 1 + \left({b}_{2}^{2} - {b}_{1}^{2}\right) {η}_{i}^{2} + O \left({η}_{i}^{4}\right) = \sqrt{\frac{β}{t {C}_{i}}}$$

When it is assumed that

$$O ( {η}_{i}^{4} ) \approx 0$$

for small ηᵢ, the solution of Equation (9) is as shown in Equation (10). At this point,

$$α = 1 \sqrt{{b}_{2}^{2} - {b}_{1}^{2}} .$$

$${η}_{i} = \sqrt{\frac{\sqrt{\frac{β}{t {C}_{i}}} - 1}{{b}_{2}^{2} - {b}_{1}^{2}}} = α \sqrt{\sqrt{\frac{β}{t {C}_{i}}} - 1}$$

In Equation (10) shown above, ηᵢ=0 when tCᵢ = β, which makes the two functions be continuously connected. If the two cases are combined when tCᵢ > β and tCᵢ ≤ β, the solution of Equation (7) is given as shown in Equation (11). In this case, α, β > 0 are hyperparameters.

$${η}_{i} = α \sqrt{m a x \left(\sqrt{\frac{β}{t {C}_{i}} - 1 , 0}\right)}$$

In Equation (11), the larger the Ci, the smaller the nᵢ. Therefore, important neurons are consolidated in subsequent learnings. However, when Ci=0, ηᵢ diverges. This may be explained from the perspective of the plasticity-stability dilemma. When a neuron has no knowledge at all, it is desirable to learn the new knowledge as much as possible without considering the cost of existing knowledge. However, this is actually wrong since even when the neuron has no knowledge to lose, it is a learning rate appropriate to increase learning efficiency although the learning rate is not so great. Therefore, in an embodiment, an upper bound of the learning rate is set so as not to generate a problem due to a large learning rate. The final solution of Equation (7) is as shown in Equation (12).

$${η}_{i} = m i n ( {η}_{m a x} , α \sqrt{m a x \left(\sqrt{\frac{β}{t {C}_{i}} - 1 , 0}\right)}$$

Method 1 shown below is an NPC method according to an embodiment. Although the NPC method according to an embodiment is designed to be executed without a predetermined learning schedule, it is unavoidable to compute the loss of each task as it requires knowledge of a task to which the current training sample belongs. However, additional task-specific information, such as a latest parameter set optimized for each task, is not required. Considering that it is simply computed from the activation and gradient, which are computed by the back-propagation method, the overhead for implementing NPC according to an embodiment is minimal.

Algorithm 1 Nueron-level Plasticity Control (NPC)

f: nueral network model
nᵢ: i-th nueron in f
wⱼᵢ: weight of connection from nj to ni
ηₘₐₓ: upper bound of learning rate
α, β: hyperparameters
Cᵢ: importance of i-th nueron
t=1
Cᵢ ← 0, Ɐi
for input, label in full training dataset do
y ← f(input)
L ← CrossEntropy(y, label)
for ni in f do
${c}_{i} ← {}_{b a t c h}^{a v e r a g e} \left|{n}_{i} \frac{d L}{d {n}_{i}}\right|$
${\hat{\text{c}}}_{\text{i}} ← {\text{c}}_{\text{i}} / \sqrt{{\sum }_{\text{layer}} {\left({\text{c}}_{\text{j}}\right)}^{2} / {\text{N}}_{\text{layer}}}$
${C}_{i} ← δ {C}_{i} + \left(1 - δ\right) {\hat{c}}_{i}$
${η}_{i} ← m i n \left({η}_{m a x} , α \sqrt{m a x \left(\left(\frac{β}{t {C}_{i}} - 1 , 0\right)\right)}\right)$
${w}_{j i} ← {w}_{j i} - {η}_{i} \frac{d L}{d {w}_{i}} , ∀ j$
end for
$\text{t} ← \text{t+1}$
end for

### Instance Normalization

Batch normalization (BN) plays an important role in the training of deep neural networks [see Ioffe Szegedy (2015) Ioffe and Szegedy]. However, since the mean and the variance are greatly affected by switching of tasks, the vanilla batch normalization does not work well in a continual learning environment. In this case, there are a few alternatives, such as conditional batch processing normalization [see DeVries et al. (2017) DeVries, Strub, Mary, Larochelle, Pietquin and Courville] and virtual batch normalization [see Salimans et al. (2016) Salimans, Goodfellow, Zaremba, Cheung, Radford and Chen]. However, although these two methods may be applied to SNPC according to an embodiment, they are not appropriate for NPC according to another embodiment since the methods maintain task-specific information. Therefore, in an embodiment, a simplified version of instance normalization, from which the affine transforms and the moving average are removed, is applied [see Ulyanov et al. (2016) Ulyanov, Vedaldi and Lempitsky]. Considering that the instance normalization may be independently applied to each sample, it operates without any special manipulation of model parameters at the time of test, as well as at the time of training.

### Scheduled NPC

### NPC Using Learning Schedule

NPC according to an embodiment does not depend on a predetermined learning schedule. However, when a task switching schedule is available, it is desirable to actively use the information to improve performance. Although the learning schedule is not determined in advance actually, recent studies on continual learning have been evaluated under similar circumstances. [see Li Hoiem (2018) Li and Hoiem, Shin et al. (2017) Shin, Lee, Kim, and Kim, Kamra et al. (2017) Kamra, Gupta, and Liu, Gepperth Karaoguz(2016)Gepperth and Karaoguz, Lopez-Paz (2017) , Fernando et al. (2017) Fernando, Banarse, Blundell, Zwols, Ha, Rusu, Pritzel, and Wierstra, Lee et al. (2017) Lee, Yun, Hwang, and Yang, Aljundi et al. (2017) Aljundi, Chakravarty, and Tuytelaars, Kirkpatrick et al. (2017) Kirkpatrick, Pascanu, Rabinowitz, Veness, Desjardins, Rusu, Milan, Quan, Ramalho, Grabska-Barwinska, et al., Lee et al. (2017) Lee, Kim, Jun, Ha, and Zhang, Nguyen et al. (2017) Nguyen, Li, Bui, and Turner, Liu et al. (2018) Liu, Masana, Herranz, Van~de Weijer, Lopez, and Bagdanov, Zenke et al. (2017) Zenke, Poole, and Ganguli, Zacarias Alexandre (2018) Zacarias and Alexandre, Kim et al. (2018) Kim, Kim, and Lee] .

Method 2 shown below presents a Scheduled Neuron-level Plasticity Control (SNPC) method according to another embodiment, which is an extension of NPC designed to more actively utilize knowledge of a task switching schedule.

Method 2 Scheduled Neuron-level Plasticity Control (SNPC)

f: neural network model shared among multiple tasks
nᵢ: i-th neuron in f
wⱼᵢ: weight of connection from nj to ni
Tₖ: k-th task for continual learning
rₖ: ratio of neurons assigned for Tₖ
nₘₐₓ: upper bound of learning rate
α, β: hyperparameters
for Tₖ in {T} do
0. Initialize Ci=0, ∀i
1. Train f for Tₖ with Method 1. evaluating Ci.
2. For each layer, select top rₖ × N_{layer} neurons from each layer with the biggest Ci among free neurons.
3. Fix the connections from other free neurons to the selected neurons to zero.
4. Train f for Tₖ by using Method 1 for a few epochs.
5. Fix wⱼᵢ’s for the selected neurons.
end for

When learning begins, all neurons are free (i.e., may learn any task) since no neurons are assigned to a specific task. When a schedule is given, SNPC according to another embodiment selects a subset of free neurons most important to each task and assigns it to the task. Then, the selected neurons are protected from the effect of free neurons that can be modified in an unpredictable way while learning other tasks. This is achieved by freezing connection weights from the free neurons to the selected neurons to zero. However, when connections from the free neurons to the selected neurons are removed in this way, it may generate potential problems. First, the capacity of the neural network may be reduced. Second, new knowledge may prevent improving performance of the network for previous tasks. Although the first problem may severely affect the performance when the model capacity is insufficient for the total sum of all tasks, it can be alleviated comparatively easily in a larger neural network. Although the second problem has a remote possibility, this phenomenon is almost unpredictable in practice. When knowledge of previous tasks is not maintained in any way, catastrophic forgetting may occur almost at all times due to changes in unconsolidated neurons.

### Per-task Neuron Allocation

SNPC according to another embodiment determines the number of neurons to be allocated to each task by rₖxN layers (here, rₖ is Yₖrₖ = 1, which is the ratio of neurons allocated to Tₖ). SNPC according to another embodiment improves the balance between tasks and simplicity by sharing the same values in all layers.

However, when it is considered that usefulness of connections from previously consolidated neurons is not comparable to that of neurons directly allocated to a corresponding task, rₖ should not be evenly distributed (r₁=r₂=...=rₖ) among the tasks. When the former is more useful than the latter as much as µ<1 times, the total usefulness of the connections that can be used for task Tₖ is proportional to Vₖ according to Equation (13) shown below. Here, the first term denotes the total usefulness of connections between neurons allocated to Tₖ, and the second term denotes the total usefulness of connections from previously consolidated neurons to the neurons for Tₖ.

$${V}_{k} = {r}_{k}^{2} + u {r}_{k} \left({r}_{1} + {r}_{2} + ⋯ + {r}_{k - 1}\right) = {r}_{k}^{2} + u {r}_{k} \sum {}_{l = 1}^{k - 1} {r}_{l}$$

Therefore, all Vₖ should be equal for all operations for the sake of fair distribution. Since this constraint generally represents a nonlinear relationship without having a solution of a closed form, a solution is found numerically. When five tasks are learned (k=5), the neural network shows balanced results when µ=0.5 and the values of rₖ are 0.2862, 0.2235, 0.1859, 0.1610, and 0.1433, respectively. The optimal distribution may be affected by other factors, such as difficulty of a task or similarity between tasks. However, these task-specific factors are not considered in this study.

### Experiments

### Datasets and Implementation Detail

Experiments on incremental versions of MNIST datasets [see LeCun et al. (1998) LeCun, Bottou, Bengio, and Haffner] and CIFAR100 [see Krizhevsky Hinton (2009) Krizhevsky and Hinton] have been conducted. Here, a dataset containing L classes are divided into K subsets of L/K classes, each of which is classified by the k-th task. In the cases of MNIST and CIFAR100, K is set to 5. For the sake of preprocessing, random cropping with a padding size of 4 is applied to both of the two datasets, and an additional random horizontal flip for the incremental CIFAR100 (iCIFAR100) dataset is applied. In addition, in order to maintain consistency, the unit of one epoch is redefined in all experiments as a cycle in which the total number of training data is displayed. For example, since there are 60,000 training samples in the original MNIST dataset, one epoch of the iMNIST dataset is defined as processing of 12,000 samples five times. With the new definition of an epoch, the model has been trained for 10 epochs on a subset for each task of iMNIST, and the model is trained for 30 epochs on each subset of iCIFAR100. The first five subsets of iCIFAR100 are used in this experiment. A mini batch size of 256 has been used for all tasks.

A slightly modified VGG-16 [see Simonyan Zisserman (2014) Simonyan and Zisserman] network is used. As described above, all batch normalization layers are replaced with instance normalization layers. In the case of the final classification layer, a fully-connected layer is arranged for each target task. The cross-entropy loss for each task is computed only at the output node belonging to the current task.

In all experiments, α=0.1 and ηₘₐₓ=0.1 are set. In the case of NPC according to an embodiment, β is set to 200. However, in the case of SNPC according to another embodiment, since the learning rate of important nodes does not need to be completely dropped to 0, a larger value of 500 is set for SNPC according to another embodiment. A plain SGD optimizer with a mini-batch size of 256 is used in all experiments.

Three conventional learning methods including EWC, L2 regularization, and baseline SGD are implemented for comparison. In the case of EWC, λ=1000 is set to show the best performance in the experimental environment. When the NPC method according to an embodiment is not used, the learning rate is set to 0.01.

### Experimental Results

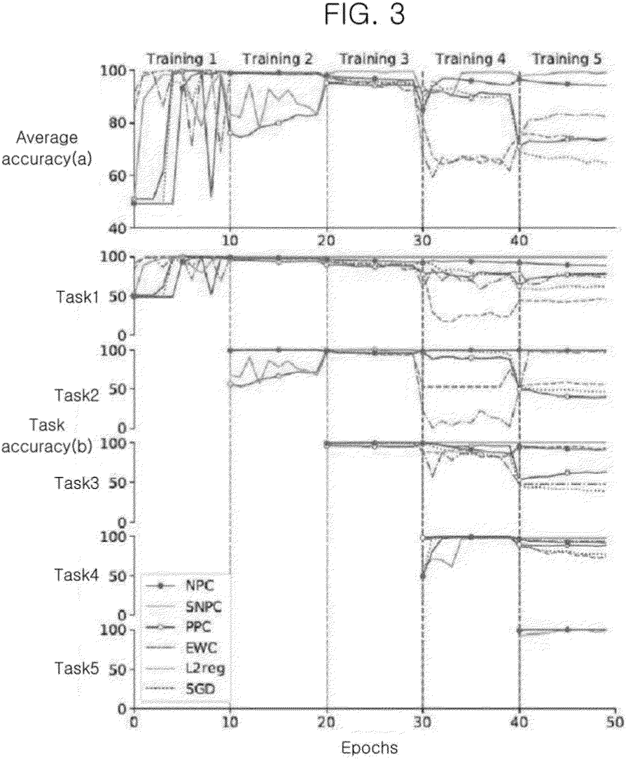

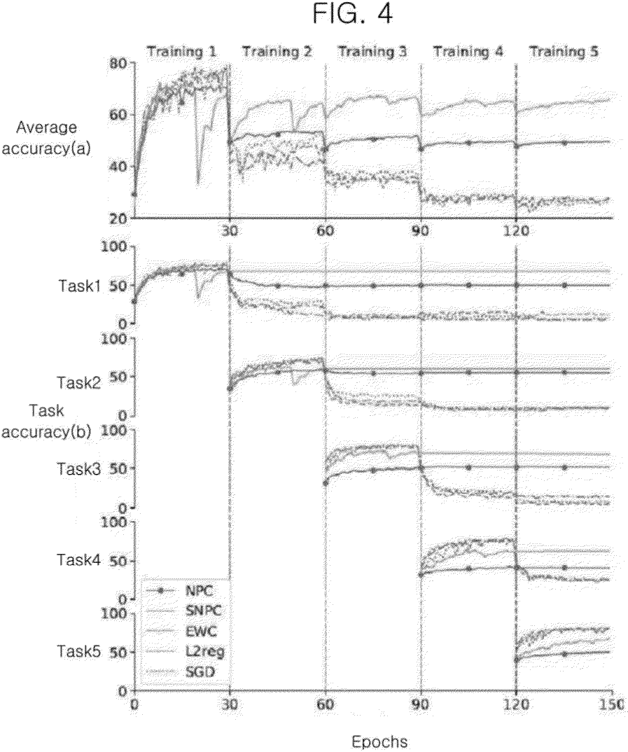

FIGS. 3 and 4 show performance of five continual learning methods (NPC, SNPC, EWC, L2 regularization, and SGD) in iMNIST and iCIFAR100, respectively. In FIG. 3, NPC and SNPC according to respective embodiments show further excellent performance than EWC and L2 regularization from the perspective of average accuracy. Their training curves show that when the network is trained by NPC or SNPC according to respective embodiments, the knowledge learned earlier is much less affected by the knowledge learned later. In particular, in the case of SNPC, performance of the first task is almost unaffected by subsequent learnings. The results show that SNPC according to another embodiment alleviates catastrophic forgetting for iMNIST until the point where its effect disappears.

Additional configurations are tested for the iMNIST dataset. Parameter-wise plasticity control (PPC) controls plasticity at the connection level, not the neuron level. Like NPC according to an embodiment, importance is evaluated using the Taylor criterion. β=300 is used, and this is the minimum value of β that allows the PPC to sufficiently learn the last task of the iMNIST method. Performance of PPC is worse than that of NPC according to an embodiment, and this confirms that neurons are more appropriate than connections as units of neural network consolidation.

FIG. 4 shows that NPC and SNPC methods according to embodiments described herein provide average accuracy higher than those of other methods in iCIFAR100, and it is more difficult to achieve than in iMNIST. However, in the case of NPC according to an embodiment, accuracy of the last task is lower than that of the previous task. Although the same problem is observed in other methods, this is more severe in the case of NPC according to an embodiment. It is assumed that the main reason is that partial consolidation of neural networks consumes learning capacity of the model. This issue is not clearly observed in iMNIST. It is since that the VGG network may have mastered subsequent tasks with minimal capacity provided by the other neurons owing to simplicity thereof. Such a difference between the NPC and SNPC embodiments shows that the NPC embodiment preserves existing knowledge better, but consumes learning capacity of the model more rapidly. That is, since the NPC embodiment has no limitation or regularization on the number of neurons allocated per task, the model generally tends to use most of the neurons for previous tasks. Accordingly, the NPC embodiment consolidates a considerable number of neurons to protect knowledge of previous tasks from catastrophic forgetting, and as a result, performance in the last task is lowered as shown in FIG. 4. However, SNPC according to another embodiment suffers less difficulty caused by the capacity exhaustion problem since only rₖ×N_{layer} neurons are consolidated for each task, and ensures that subsequent tasks utilize a specific number of neurons.

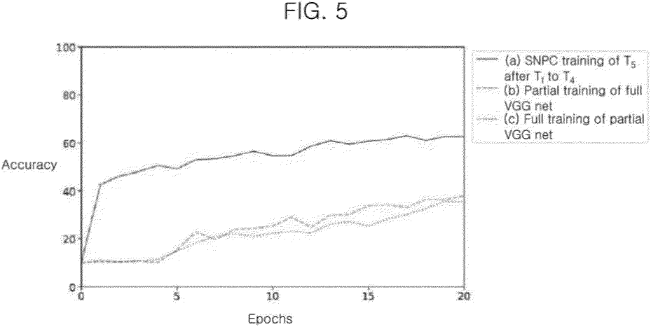

In addition, it is observed that the neural network learns subsequent tasks faster than previous tasks for continual learning. The reason is that since the neural network utilizes the knowledge learned in the previous tasks, the subsequent tasks may benefit from the transferred knowledge. To make it clear, a simple experiment has been conducted to test whether the SNPC embodiment reuses the knowledge previously trained from previous tasks while learning the last task. Three VGG network instances are trained in iCIFAR100 using only 14.33% of neurons (a proportion equal to r₅) in different settings. In FIG. 5, curve (a) shows the learning curve of the SNPC embodiment training T₅ after four precedent tasks. Curve (b) shows that only 14.33% of neurons connected to other randomly initialized and fixed neurons are trained. Finally, dotted curve (c) is the learning curve when the network learns only 14.33% of neurons, starting from randomly initialized parameters. FIG. 5 shows that the SNPC embodiment learns tasks much faster than in the other two settings. This confirms that the SNPC embodiment actively reuses the knowledge obtained from previous tasks.

### Conclusion

Two continual learning methods of NPC according to an embodiment and SNPC according to another embodiment, which control plasticity of neural networks at the neuron level, have been described. NPC according to an embodiment does not maintain information such as a latest set of parameters optimized for each task. Therefore, it may be executed without a predefined training schedule. On the other hand, SNPC according to another embodiment has and actively utilizes a predefined learning schedule to more explicitly protect important neurons. According to the results of experiments on the iMNIST and iCIFAR100 datasets, NPC according to an embodiment and SNPC according to another embodiment are much more effective than conventional connection-level consolidation methods that do not consider the relation among connections. In particular, catastrophic forgetting almost disappears in the results of the SNPC embodiment on the iMNIST dataset.

Although NPC and SNPC according to embodiments are significantly improved in the continual learning, problems to be solved still remain. Although dependency of the NPC embodiment on information is minimal, it is still limited by the fact that tasks should be identified to compute a classification loss. In addition, although the NPC embodiment defines the units and methods for controlling plasticity, strategies for evaluating and managing importance of each neuron are still being explored.

The experiment is focused more on proving the concept in a continual learning environment, rather than showing the best performance in the classification. For example, a latest classification model such as [see AmoebaNetReal et al. (2018) Real, Aggarwal, Huang, and Le] shows much higher capacity than VGG in a single working environment. Another choice in favor of simplicity is instance normalization, and this may not be the best choice for performance.

Residual connections [see He et al. (2016) He, Zhang, Ren, and Sun] are one of the obstacles that should be solved to apply NPC embodiment to more diverse architectures. Interpreting summation of multiple neuron outputs and determining neurons that should be preserved is a non-obvious problem, especially when important and unimportant neurons are added.

As a general online learning benchmark such as iCIFAR100 does not revisit the same task, the model may cause catastrophic forgetting by simply blocking passages. However, in a situation where a task can be trained two or more times, it is desirable to further improve the model by consolidating the knowledge acquired while learning subsequent tasks. This is not a problem of NPC according to an embodiment, but may be a problem of SNPC according to another embodiment considering that neurons for subsequent tasks may grow large depending on neurons for previous tasks. In addition to using a sufficiently small learning rate, one of simple solutions is to treat a revisited task as if it is a new task. However, although this may alleviate the effect of catastrophic forgetting, it may generate a practical problem in the long run as the capacity of the model should be much larger.

Similar to the Taylor criterion used for evaluation of importance, studies on the network theorem show how a deep learning model may learn complex knowledge at a surprisingly small size. However, when there is not explicit intervention, deep neural networks tend to consume more capacity than actually needed. Although the SNPC embodiment avoids this problem by allocating task-specific neurons, the NPC embodiment is not excluded from this problem as the model capacity is exhausted when tasks are accumulated. It is observed that first few tasks tend to occupy most of models regardless of a model size. It is believed that the NPC embodiment would benefit greatly when the model has a method of forcing to use a minimum capacity per task.

The method of overcoming catastrophic forgetting through neuron-level plasticity control (NPC) according to an embodiment or scheduled NPC (SNPC) according to another embodiment may be performed by a computing system.

The computing system denotes a data processing device having a computing ability for implementing the processing functions as described above, and generally, those skilled in the art may easily infer that any device capable of performing a specific service, such as a personal computer, a portable terminal or the like, as well as a data processing device, such as a server or the like, that can be accessed by a client through a network, may be defined as a computing system.

The computing system may be provided with hardware resources and/or software needed to implement the embodiments described above, and does not necessarily denote a physical component or a device. That is, the computing system may denote a logical combination of hardware and/or software provided to implement the spirit of the present invention, and may be implemented as a set of logical components if needed by being installed in the devices separated from each other and performing their functions to implement the embodiments described above. In addition, the computing system may denote a set of components separately implemented for each function or role for implementing the embodiments described above. The predictive model generation system may be implemented in the form of a plurality of modules.

In addition, as described herein, a module may denote a functional or structural combination of hardware for performing the methods described herein and software for driving the hardware. For example, those skilled in the art may easily infer that the module may denote a predetermined code and a logical unit of hardware resources for executing the predetermined code, and does not necessarily denote a physically connected code or a single type of hardware.

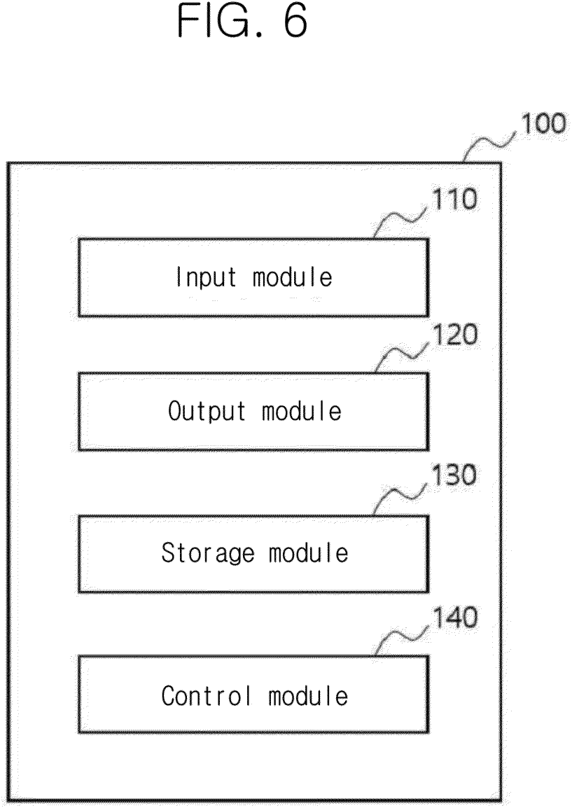

FIG. 6 is a view showing the configuration of a computing system according to an embodiment.

Referring to FIG. 6, the computing system 100 may include an input module 110, an output module 120, a storage module 130, and a control module 140.

The input module 110 may receive various data needed for implementing the methods according to one or more embodiments from the outside of the computing device 110 (external to the computing system 100). For example, the input module 110 may receive training datasets, various parameters, and/or hyperparameters.

The output module 120 may output data stored in the computing system 100 or data generated by the computing system 100 to the outside (external to the computing system 100).

The storage module 130 may store various types of information and/or data needed for implementing the embodiments described herein For example, the storage module 130 may store neural network models, training data, and various parameters and/or hyperparameters. The storage module 130 may include volatile memory such as Random Access Memory (RAM) or non-volatile memory such as a Hard Disk Drive (HDD) or a Solid-State Disk (SSD).

The control module 140 may control other components (e.g., the input module 110, the output module 120, and/or the storage module 130) included in the computing system 100. The control module 140 may include a processor such as a single-core CPU, a multi-core CPU, or a GPU.

In addition, the control module 140 may perform neuron-level plasticity control (NPC) according to an embodiment or scheduled NPC (SNPC) according to another embodiment based on the studies described above. For example, the control module 140 may apply the neural network models and training data stored in the storage module 130 to the NPC methods or the SNPC methods described above.

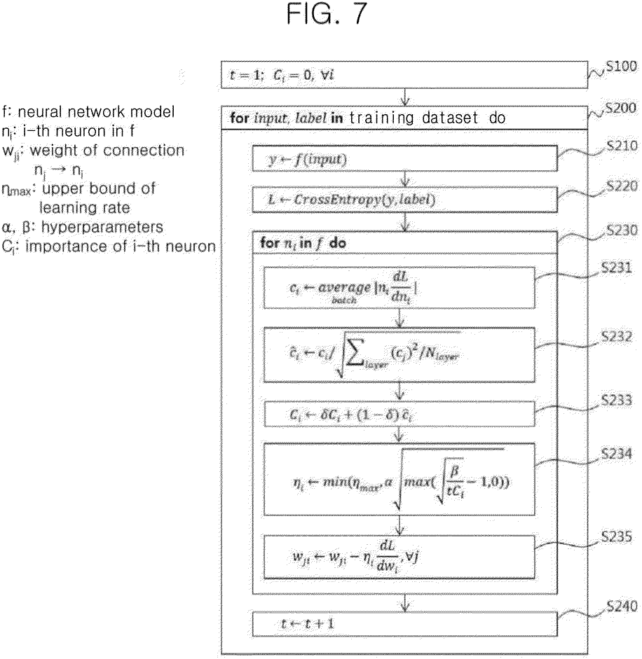

FIG. 7 is a flowchart illustrating a neuron-level plasticity control method performed by the control module 140.

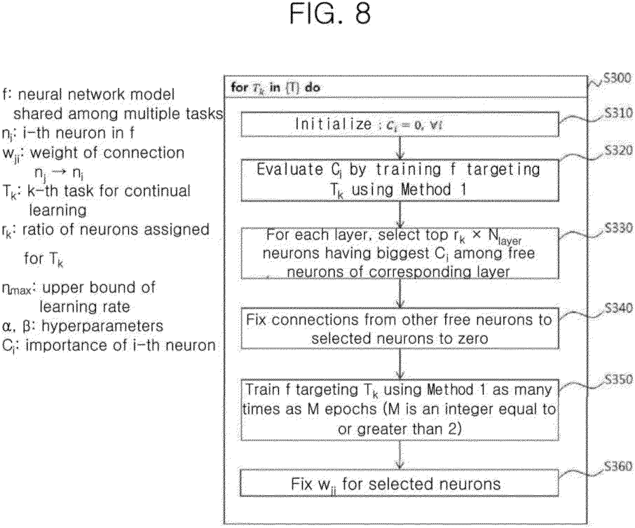

FIG. 8 is a flowchart illustrating a scheduled neuron-level plasticity control method performed by the control module 140.

According to an implementation example, the computing system 100 may include at least a processor and a memory for storing programs executed by the processor. The processor may include single-core CPUs or multi-core CPUs. The memory may include highspeed random-access memory and may include one or more non-volatile memory devices such as magnetic disk storage devices, flash memory devices, and other non-volatile solid state memory devices. Access to the memory by the processor and other components may be controlled by a memory controller.

The method according to an embodiment may be implemented in the form of a computer-readable program command and stored in a computer-readable memory or recording medium. The computer-readable recording medium includes all types of recording devices for storing data that can be read by a computer system.

The program commands recorded in the recording medium may be specially designed and configured for implementation of the embodiments described herein, or may be known to and used by those skilled in the software field.

Examples of the computer-readable recording medium include magnetic media such as hard disks, floppy disks, and magnetic tapes, optical media such as CD-ROMs and DVDs, magnetooptical media such as floptical disks, and hardware devices specially configured to store and execute program commands, such as ROM, RAM, flash memory and the like. In addition, the computer-readable recording medium may be distributed in computer systems connected through a network to store and execute computer-readable codes in a distributed manner.

Examples of program instructions include high-level language codes that can be executed by a device that electronically processes information using an interpreter or the like, e.g., a computer, as well as machine language codes such as those produced by a compiler.

The hardware device described above may be configured to execute as one or more software modules to perform the operation of the embodiments described herein, and vice versa.

The above description of the present invention is for illustrative purposes, and those skilled in the art may understand that it is possible to easily transform into other specific forms without changing the essential features of the embodiments described herein. Therefore, it should be understood that the embodiments described above are illustrative and non-limiting in all respects. For example, each component described as a single form may be implemented in a distributed manner, and in the same manner, components described as being distributed may also be implemented in a combined form.

The scope of the embodiments described herein is indicated by the claims described below, rather than the detailed description described above, and all changes or modifications derived from the understanding and scope of the claims and their equivalents should be construed as being included in the scope of the embodiments described herein.

With respect to industrial applicability, one or more embodiments may be used as a method of overcoming catastrophic forgetting through neuron-level plasticity control, and as a computing system for performing the same, in which the computing system has an improved operability as compared to other artificial neural-network computing systems and in which the method has an improved performance as compared to other artificial neural-network computing methods. For example, systems and methods according to one or more embodiments may increase efficiency of memory used in an artificial neural-network computing system in addition to increasing the efficiency of the NPC embodiment, regardless of the number of tasks. That is, since the NPC embodiment only needs to store a single importance value per neuron, less memory is required to perform a task as would be required for conventional EWC artificial neural-network computing system, thereby improving the operability of an artificial neural-network computing system constructed according to principles of the invention.

1. A neuron-level plasticity control method for an artificial neural network model configured of first to N-th neurons, wherein N is an integer equal to or greater than 2, the method comprising the steps of:
receiving a predetermining training dataset;
performing, by a computing system, a weight adjustment process on each of a plurality of individual data included in the predetermined training dataset based on the individual data in which a corresponding correct answer label is assigned to each of the plurality of individual data, wherein
the step of performing a weight adjustment process based on the individual data includes the steps of:
inputting the individual data into the artificial neural network model to acquire a predicted value corresponding to the individual data;
computing a cross entropy based on the predicted value and the correct answer label assigned to the individual data; and
adjusting weights of all connections that use neuron nᵢ as an incoming node, for each neuron nᵢ included in the artificial neural network model, wherein i is an integer of 1 <=i<=N, wherein
the step of adjusting weights of all connections that use neuron nᵢ as an incoming node includes the steps of:
computing importance Ci of the neuron nᵢ, which is a moving average of a normalized Taylor criterion;
computing a learning rate ηᵢ of the neuron nᵢ based on [Equation 1]; and
updating the weights of all connections that use neuron nᵢ as an incoming node through a gradient descent to which the computed learning rate ηᵢ is applied
$${\text{η}}_{\text{i}} = m i n \left({η}_{m a x} , α \sqrt{m a x \left(\sqrt{\frac{β}{t {C}_{i}} - 1 , 0}\right)}\right)$$
wherein, α and β are predefined hyperparameters of the artificial neural network model, ηₘₐₓ is an upper bound of a predefined learning rate, and t is a sequence number of the individual data in the training dataset.

2. A scheduled neuron-level plasticity control method for an artificial neural network model, the method comprising the steps of:
acquiring, by a computing system, a training dataset corresponding to each of a plurality of tasks, which are targets of continual learning; and
performing, by the computing system, a learning process corresponding to the task, for each of the plurality of tasks, wherein
the step of performing a learning process corresponding to the task includes the steps of:
performing, by the computing system, a neuron-level plasticity control method using a training dataset corresponding to the task;
selecting, by the computing system, for each of a plurality of layers configuring the artificial neural network, some important neurons having greatest importance among free neurons included in the layer;
fixing weights of all connections from the free neurons to the important neurons in the artificial neural network to 0;
repeating, by the computing system, the neuron-level plasticity control method using a training dataset corresponding to the task as many times as two or more epochs; and
fixing the weights of all connections that use the important neurons as incoming nodes.

3. A computer program installed in a data processing device and stored in a recording medium to perform the method according to claim 1.

4. A computer program installed in a data processing device and stored in a recording medium to perform the method in according to claim 2.

5. A computing system comprising:
a processor; and
a memory for storing a computer program executed by the processor, wherein the computer program, when executed by the processor, operates the computing system to perform the method in according to claim 1.

6. A computing system comprising:
a processor; and
a memory for storing a computer program executed by the processor, wherein the computer program, when executed by the processor, operates the computing system to perform the method in according to claim 2.
